(19) United States
(12) Patent Application Publication
(10) Pub. No.: US 2026/0250133 A1
(43) Pub. Date: Aug. 27, 2026

(54) METHOD FOR PRODUCING LITHIUM DIFLUOROPHOSPHATE IN ECONOMICAL MANNER

(71) Applicant: EVS TECHNOLOGIES, INC., Daejeon (KR)

(72) Inventor: Kwang Min LIM, Yongin-si (KR)

(21) Appl. No.: 19/475,895

(22) PCT Filed: Aug. 14, 2023
(86) PCT No.: PCT/KR2023/012030

§ 371 Date: Oct. 16, 2025

(30) Foreign Application Priority Data
Nov. 4, 2022 (KR) 10-2022-0146170
Jun. 23, 2023 (KR) 10-2023-0081172

(51) Int. Cl. C01B 25/455; H01M 10/0567

(52) U.S. Cl. CPC C01B 25/455; H01M 10/0567; C01P 2006/80

(57) ABSTRACT

The present invention relates to an economical method for producing lithium difluorophosphate, wherein the method for producing lithium difluorophosphate can economically produce lithium difluorophosphate having a high yield of 80% or more and a high purity of 99% or more through a simple method without using expensive reagents and without complicated processes, and has the advantage that, by quantitatively introducing an aqueous solution of hydrofluoric acid, no additional introduction of water is required, and since excessive hydrofluoric acid gas is not used, the danger of the production process and the process and danger of treating excessive hydrofluoric acid gas after production can be reduced.

### TECHNICAL FIELD

The present invention relates to a method for producing lithium difluorophosphate, and more particularly, to a method for producing lithium difluorophosphate (LiPO₂F₂) without using expensive lithium hexafluorophosphate (LiPF₆), but by employing P(═O)X₃ (wherein X is any one of F, Cl, Br, or I), which is relatively inexpensive and easily obtainable, as a starting material.

### BACKGROUND ART

Recently, with the rapid increase in the development of electric vehicles (EV) and electric storage systems (ESS), there has arisen a need for high-performance lithium secondary batteries having characteristics such as high output, high energy density, and high discharge voltage.

Among the compositions of electrolytes suitable for such required performance, the importance of electrolyte additives has become necessary, and in particular, it has been revealed that lithium difluorophosphate compounds have excellent required performance. Accordingly, there has arisen a necessity to mass-produce lithium difluorophosphate economically.

When schematizing the conventional method for producing lithium difluorophosphate, it is as shown in the following Reaction Formula 1.

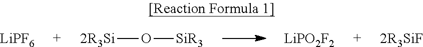

This is a method of producing lithium difluorophosphate by carrying out a heating reaction of various siloxanes and lithium hexafluorophosphate in a water-free state.

The above method has the advantage that acidic gas is not generated and inorganic salts are not generated, but since the price of siloxane is expensive and its reactivity is low, the reaction does not proceed at room temperature, and when carrying out a heating reaction at about 60° C., a large amount of insoluble impurities is generated, and organofluorosilane (R₃SiF), which is a volatile organic compound, is produced as a by-product, so that it is economically burdensome and environmentally problematic in that it must be discarded or recycled so as not to cause problems to the environment of VOCs (Volatile Organic Compounds), and thus there is a problem in that it is not suitable for use as an electrolyte of a lithium secondary battery.

When schematizing another method of producing lithium difluorophosphate in addition to the above method, it is as shown in the following Reaction Formula 2.

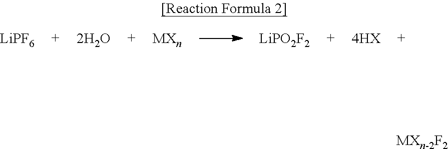

As the substance that can be used as MXₙ in the above reaction formula, there are lithium chloride, lithium bromide, silicon tetrachloride, silicon tetrabromide, acetyl chloride, acetyl bromide, propionyl chloride, and oxalyl chloride.

As shown in the above reaction formula, lithium hexafluorophosphate (LiPF₆) is reacted with water and a halogen compound to produce lithium difluorophosphate (LiPO₂F₂). At this time, the generated acidic gas and salts must be removed by evaporation and precipitation.

In addition, when using silicon tetrachloride and the like as MXₙ, it is a starting material that is highly corrosive and easily decomposes in air, making it difficult to handle, and when using acetyl chloride, acetyl bromide, propionyl chloride, oxalyl chloride, and the like as MXₙ, the reactivity is low so that it must be used in excess, and accordingly, residual substances must be recovered, and thus it involves cumbersome and dangerous processes in commercial production.

As described above in [Reaction Formula 1] and [Reaction Formula 2], most of the conventional methods for producing lithium difluorophosphate use lithium hexafluorophosphate (LiPF₆) as a starting material.

However, as the market for lithium secondary batteries has recently expanded explosively, the demand for lithium hexafluorophosphate (LiPF₆), which is the main electrolyte of small- and medium-to-large-sized lithium secondary batteries, has greatly increased, and the market price has soared to 4 to 5 times as of 2022 compared to 2019, so that the conventional method of producing lithium difluorophosphate using lithium hexafluorophosphate (LiPF₆) as a raw material has very great difficulty in securing cost competitiveness of lithium difluorophosphate due to the price surge of lithium hexafluorophosphate (LiPF₆), which is the main raw material.

Accordingly, there is a very great need for a new method of producing lithium difluorophosphate used in an electrolyte for lithium secondary batteries more simply and economically than the conventional production method.

### PRIOR ART DOCUMENTS

### Patent Documents

(Patent Document 1) Korean Registered Patent No. 10-131707 (Published on Nov. 17, 2009)

### DISCLOSURE OF THE INVENTION

### Technical Problem

The object of the present invention is to provide a method for producing high-purity lithium difluorophosphate by using an economical and efficient method.

### Technical Solution

The present invention provides a method for producing lithium difluorophosphate, comprising the step of producing lithium difluorophosphate powder by reacting after adding an aqueous solution of hydrofluoric acid and a lithium compound to a mixture obtained by mixing a phosphoryl halide compound and an organic solvent and cooling the mixture, wherein the halide (X) of the phosphoryl halide compound (POX₃) is one or more selected from the group consisting of fluoride (F), chloride (Cl), bromide (Br), and iodide (I).

In addition, the present invention provides lithium difluorophosphate produced according to the above-described method for producing lithium difluorophosphate.

### Advantageous Effects

The method for producing lithium difluorophosphate according to the present invention can economically produce lithium difluorophosphate having a high yield of 80% or more and a high purity of 99% or more through a simple method without using expensive reagents and without complicated processes.

In addition, the method for producing lithium difluorophosphate according to the present invention has the advantage that, by quantitatively introducing an aqueous solution of hydrofluoric acid, no additional introduction of water is required, and since excessive hydrofluoric acid gas is not used, the danger of the production process and the process and danger of treating excessive hydrofluoric acid gas after production can be reduced.

In addition, lithium difluorophosphate produced according to the present invention is inexpensive and has high purity with few impurities, and when used in an electrolyte for a lithium secondary battery, it can improve the electrochemical characteristics, output, and lifespan characteristics of the lithium secondary battery, and thus can be widely applied to lithium secondary batteries.

### MODE FOR CARRYING OUT THE INVENTION

Hereinafter, the present invention will be described in more detail.

Conventionally, in order to produce lithium difluorophosphate (LiPO₂F₂), lithium hexafluorophosphate (LiPF₆) has mostly been used as a starting material, but the existing process, in which the molecular weight is reduced by nearly 30% and volatile by-products are generated, is not desirable environmentally or economically. In particular, due to the recent rapid increase in the lithium secondary battery industry, such as for electric vehicles, the price of lithium hexafluorophosphate (LiPF₆), which has been widely used as an electrolyte in electrolytes, has risen significantly, and thus the necessity of producing lithium difluorophosphate (LiPO₂F₂) more inexpensively is increasing.

In addition, while devising a method for economically producing lithium difluorophosphate (LiPO₂F₂) through a simple process, the present inventors, instead of using expensive lithium hexafluorophosphate (LiPF₆) as a starting material, noted that in the case of producing lithium difluorophosphate by using a phosphoryl halide compound (POX₃; X is any one of F, Cl, Br, or I), which is about ⅕ to 1/20 less expensive compared with the conventional starting material lithium hexafluorophosphate (LiPF₆), it can be produced simply and economically, and thereby completed the present invention.

The present invention provides a method for producing lithium difluorophosphate, comprising the step of producing lithium difluorophosphate powder by reacting after adding an aqueous solution of hydrofluoric acid and a lithium compound to a mixture obtained by mixing a phosphoryl halide compound and an organic solvent and cooling the mixture, wherein the halide (X) of the phosphoryl halide compound (POX₃) is one or more selected from the group consisting of fluoride (F), chloride (Cl), bromide (Br), and iodide (I).

The method for producing lithium difluorophosphate according to the present invention can produce lithium difluorophosphate by a simple method through a one-pot reaction.

The mixture of the phosphoryl halide compound and the organic solvent can be mixed at a temperature of −30° C. to 25° C. or 20° C. to 25° C.

The organic solvent may include one or more selected from the group consisting of: ethers such as diethyl ether, diisopropyl ether, or methyl-t-butyl ether; esters such as methyl acetate, ethyl acetate, propyl acetate, or butyl acetate; nitriles such as acetonitrile, propionitrile, or butyronitrile;

hydrocarbons such as pentane, hexane, heptane, or dialkoxyalkane; alcohols such as methanol, ethanol, propanol, or butanol; ketones such as acetone, ethyl methyl ketone, or methyl isopropyl ketone; carbonates such as dimethyl carbonate, diethyl carbonate, ethylene carbonate, or ethyl methyl carbonate; chloroalkanes such as methylene chloride, 1,2-dichloroethane, chloroform, or carbon tetrachloride; and aromatics such as benzene, toluene, or xylene.

The organic solvent may be included in an amount of 0.5 to 100 equivalents relative to 1 equivalent of the phosphoryl halide compound (POX₃).

The step of producing the lithium difluorophosphate powder may be carried out by cooling the mixture at a temperature of −30° C. to 25° C. or −30° C. to 5° C., and then adding an aqueous solution of hydrofluoric acid and a lithium compound to the mixture and performing the reaction by raising the temperature to 40° C. to 110° C. or 70° C. to 100° C.

Specifically, the step of producing the lithium difluorophosphate powder may comprise adding an aqueous solution of hydrofluoric acid and a lithium compound to the phosphoryl halide mixture cooled to a temperature of −30° C. to 25° C. or −30° C. to 5° C.

The aqueous solution of hydrofluoric acid may be one in which hydrofluoric acid and water are mixed in an amount of 1:0.20 to 2 equivalents.

The hydrofluoric acid of the aqueous solution of hydrofluoric acid may be included in an amount of 2.0 to 4.0 equivalents relative to 1 equivalent of the phosphoryl halide compound (POX₃).

The lithium compound may include one or more selected from the group consisting of lithium hydroxide (LiOH), lithium carbonate (Li₂CO₃), lithium bicarbonate (LiHCO₃), lithium fluoride (LiF), lithium chloride (LiCl), lithium bromide (LiBr), lithium iodide (LiI), and hydrates thereof.

Specifically, the lithium compound may be included in an amount of 1.0 to 3.0 equivalents relative to 1.0 equivalent of the phosphoryl halide compound (POX₃).

Specifically, the present invention can produce lithium difluorophosphate through the reaction processes of Reaction Formula I to Reaction Formula IV below.

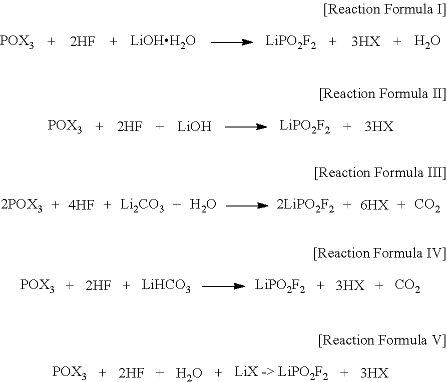

(At this time, X is F, Cl, Br, or I.)

According to Reaction Formulae I to V, the present invention can easily produce lithium difluorophosphate (LiPO₂F₂) by using an aqueous solution of hydrofluoric acid and a lithium compound with a phosphoryl halide compound (POX₃) as a starting material.

At this time, relative to 1.0 equivalent of the phosphoryl halide compound (POX₃), 2.0 to 4.0 equivalents of hydrofluoric acid, 1.0 to 3.0 equivalents of water, and 1.0 to 3.0 equivalents of a lithium compound may be respectively added.

After the step of producing the lithium difluorophosphate powder, a step of further purifying the lithium difluorophosphate may be included.

The step of further purifying may be carried out by removing hydrogen halide (HX) gas from the lithium difluorophosphate powder in which the reaction is completed at a temperature of 10° C. to 25° C. or 10° C. to 20° C., filtering, and then washing with an organic solvent to crystallize. The step of further purifying may be repeated two or more times. Specifically, the solution obtained by dissolving the lithium difluorophosphate powder in an organic solvent may be concentrated by raising the temperature to 25° C. to 60° C. and then lowering to a temperature of 10° C. to 20° C. and filtering. More specifically, the step of further purifying may be carried out by lowering the lithium difluorophosphate powder in which the reaction is completed to a temperature of 10° C. to 25° C. or 10° C. to 20° C. to induce crystallization, then filtering, and washing with an organic solvent.

The organic solvent may include one or more selected from the group consisting of: ethers such as diethyl ether, diisopropyl ether, or methyl-t-butyl ether; esters such as methyl acetate, ethyl acetate, propyl acetate, or butyl acetate; nitriles such as acetonitrile, propionitrile, or butyronitrile; hydrocarbons such as pentane, hexane, heptane, or dialkoxyalkane; alcohols such as methanol, ethanol, propanol, or butanol; ketones such as acetone, ethyl methyl ketone, or methyl isopropyl ketone; carbonates such as dimethyl carbonate, diethyl carbonate, ethylene carbonate, or ethyl methyl carbonate; chloroalkanes such as methylene chloride, 1,2-dichloroethane, chloroform, or carbon tetrachloride; and aromatics such as benzene, toluene, or xylene.

The organic solvent may be mixed in an amount of 300 to 800 parts by weight based on 100 parts by weight of the lithium difluorophosphate powder.

The step of further purifying may obtain a high-purity lithium difluorophosphate compound by drying the lithium difluorophosphate subjected to filtering.

In addition, the present invention provides lithium difluorophosphate produced according to the above-described method for producing lithium difluorophosphate.

The lithium difluorophosphate produced according to the method for producing lithium difluorophosphate of the present invention has few impurities and is inexpensive, and when used in an electrolyte for a lithium secondary battery, it can improve the electrochemical characteristics, output, and lifespan characteristics of the lithium secondary battery.

Specifically, the lithium difluorophosphate may have a purity of 95% or more or 99% or more.

The lithium difluorophosphate may be a compound represented by the following Chemical Formula 1.

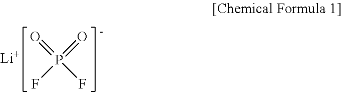

Hereinafter, the present invention will be described in more detail through Examples. These Examples are only for describing the present invention in more detail, and it will be apparent to those skilled in the art that the scope of the present invention is not limited by these Examples according to the gist of the present invention.

### Example 1. Production of Lithium Difluorophosphate Using Phosphoryl Chloride Compound (POCl₃), Aqueous Solution of Hydrofluoric Acid, Lithium Hydroxide (LiOH), and Lithium Chloride (LiCl)

Under a nitrogen atmosphere, 153.3 g of phosphoryl chloride (POCl₃) and 306.6 g of ethyl methyl carbonate were introduced at room temperature into a 1,000 mL PFA container equipped with a stirring device, a condenser, and a thermometer.

The mixture was cooled to −10° C. using an ice bath, and 50.0 g of 80% aqueous hydrofluoric acid solution, 12.0 g of lithium hydroxide (LiOH), and 21.2 g of lithium chloride (LiCl) were slowly added. While stirring the mixture, the temperature was gradually raised to 90° C. to carry out the reaction and produce lithium difluorophosphate.

After completion of the reaction, the temperature was lowered to 25° C., and the generated hydrogen chloride gas was removed under reduced pressure. The generated salts were filtered with filter paper, and then washed with a small amount of ethyl methyl carbonate. By recovering and drying the filtered salts, finally, a lithium difluorophosphate compound as a white powder was obtained (yield: 80%, purity: 99.0%).

### Example 2. Production of Lithium Difluorophosphate Using Phosphoryl Chloride Compound (POCl₃), Aqueous Solution of Hydrofluoric Acid, and Lithium Fluoride (LiF)

Under a nitrogen atmosphere, 153.3 g of phosphoryl chloride (POCl₃) and 177.0 g of dimethyl carbonate were introduced at room temperature into a 1,000 mL PFA container equipped with a stirring device, a condenser, and a thermometer.

The mixture was cooled to 5° C. using an ice bath, and 36.4 g of 53% aqueous hydrofluoric acid solution and 25.9 g of lithium fluoride were slowly added. While stirring the mixture, the temperature was gradually raised to 80° C. to carry out the reaction and produce lithium difluorophosphate.

After completion of the reaction, the temperature was lowered to 25° C., and the generated hydrogen chloride gas was removed under reduced pressure. The generated salts were filtered with filter paper, and then washed with a small amount of dimethyl carbonate. By recovering and drying the filtered salts, finally, a lithium difluorophosphate compound as a white powder was obtained (yield: 82%, purity: 99.2%).

### Example 3. Production of Lithium Difluorophosphate Using Phosphoryl Chloride Compound (POCl₃), Aqueous Solution of Hydrofluoric Acid, and Lithium Carbonate (Li₂CO₃)

Under a nitrogen atmosphere, 153.3 g of phosphoryl chloride (POCl₃) and 177.0 g of dimethyl carbonate were introduced at room temperature into a 1,000 mL PFA container equipped with a stirring device, a condenser, and a thermometer.

The mixture was cooled to 5° C. using an ice bath, and 50.0 g of 80% aqueous hydrofluoric acid solution and 37.0 g of lithium carbonate (Li₂CO₃) were slowly added. While stirring the mixture, the temperature was gradually raised to 80° C. to carry out the reaction and produce lithium difluorophosphate.

After completion of the reaction, the temperature was lowered to 25° C., and the generated hydrogen chloride gas was removed under reduced pressure. The generated salts were filtered with filter paper, and then washed with a small amount of dimethyl carbonate. By recovering and drying the filtered salts, finally, a lithium difluorophosphate compound as a white powder was obtained (yield: 81%, purity: 99.2%).

### Example 4. Production of Lithium Difluorophosphate Using Phosphoryl Chloride Compound (POCl₃), Aqueous Solution of Hydrofluoric Acid, and Lithium Chloride (LiCl)

Under a nitrogen atmosphere, 153.3 g of phosphoryl chloride (POCl₃) and 306.6 g of ethyl methyl carbonate were introduced at room temperature into a 1,000 mL PFA container equipped with a stirring device, a condenser, and a thermometer.

The mixture was cooled to −10° C. using an ice bath, and 58.0 g of 66% aqueous hydrofluoric acid solution and 42.4 g of lithium chloride (LiCl) were slowly added. While stirring the mixture, the temperature was gradually raised to 90° C. to carry out the reaction and produce lithium difluorophosphate.

After completion of the reaction, the temperature was lowered to 25° C., and the generated hydrogen chloride gas was removed under reduced pressure. The generated salts were filtered with filter paper, and then washed with a small amount of ethyl methyl carbonate. By recovering and drying the filtered salts, finally, a lithium difluorophosphate compound as a white powder was obtained (yield: 80%, purity: 99.0%).

### Example 5. Production of a High-Purity Product Through Further Purification of Lithium Difluorophosphate

Under a nitrogen atmosphere, 100 g of the lithium difluorophosphate compound as a white powder obtained in Examples 1 to 4 and 500 g of acetone were introduced at room temperature into a 1,000 mL PFA container equipped with a stirring device, a condenser, and a thermometer.

The mixture was heated to 40° C., then the temperature was lowered to 20° C., the generated insoluble matter was filtered with filter paper, the filtered liquid was concentrated, 150 g of dimethyl carbonate was introduced thereto and stirred, the generated salts were filtered with filter paper, and then washed with a small amount of dimethyl carbonate. By recovering and drying the filtered salts, finally, a high-purity lithium difluorophosphate compound as a white powder was obtained (yield: 92%, purity: 99.9%).

Accordingly, lithium difluorophosphate produced and purified according to the present invention has high purity with few impurities, and when used in an electrolyte for a lithium secondary battery, it can improve the electrochemical characteristics, output, and lifespan characteristics of the secondary battery, and thus can be widely applied to lithium secondary batteries.

As described above, although the present invention has been described by limited Examples, the present invention is not limited thereto, and various modifications and variations are possible within the technical spirit of the present invention and the equivalent scope of the claims to be described below by those of ordinary skill in the art to which the present invention pertains.

1. A method for producing lithium difluorophosphate, comprising:
cooling a mixture obtained by mixing a phosphoryl halide compound (POX₃) with an organic solvent; and
adding an aqueous hydrofluoric acid solution and a lithium compound to the cooled mixture and allowing them to react to produce lithium difluorophosphate powder;
wherein the halide (X) of the phosphoryl halide compound (POX₃) is at least one selected from the group consisting of fluoride (F), chloride (Cl), bromide (Br), and iodide (I).

2. The method for producing lithium difluorophosphate according to claim 1, wherein the aqueous solution of hydrofluoric acid is a mixture of hydrofluoric acid and water in a ratio of 1:0.20 to 2 equivalents.

3. The method for producing lithium difluorophosphate according to claim 1, wherein hydrofluoric acid in the aqueous solution of hydrofluoric acid is included in an amount of 2.0 to 4.0 equivalents relative to 1 equivalent of the phosphoryl halide compound (POX₃).

4. The method for producing lithium difluorophosphate according to claim 1, wherein the lithium compound comprises one or more selected from the group consisting of lithium hydroxide (LiOH), lithium carbonate (Li₂CO₃), lithium bicarbonate (LiHCO₃), lithium fluoride (LiF), lithium chloride (LiCl), lithium bromide (LiBr), lithium iodide (LiI), and hydrates thereof.

5. The method for producing lithium difluorophosphate according to claim 1, wherein the organic solvent comprises one or more selected from the group consisting of: ethers such as diethyl ether, diisopropyl ether, or methyl-t-butyl ether; esters such as methyl acetate, ethyl acetate, propyl acetate, or butyl acetate; nitriles such as acetonitrile, propionitrile, or butyronitrile; hydrocarbons such as pentane, hexane, heptane, or dialkoxyalkane; alcohols such as methanol, ethanol, propanol, or butanol; ketones such as acetone, ethyl methyl ketone, or methyl isopropyl ketone; carbonates such as dimethyl carbonate, diethyl carbonate, ethylene carbonate, or ethyl methyl carbonate; chloroalkanes such as methylene chloride, 1,2-dichloroethane, chloroform, or carbon tetrachloride; and aromatics such as benzene, toluene, or xylene.

6. The method for producing lithium difluorophosphate according to claim 1, wherein the organic solvent is included in an amount of 0.5 to 100 equivalents relative to 1 equivalent of the phosphoryl halide compound (POX₃).

7. The method for producing lithium difluorophosphate according to claim 1, wherein the step of producing the lithium difluorophosphate powder is carried out by cooling the mixture at a temperature of −30° C. to 25° C., and then adding an aqueous solution of hydrofluoric acid and a lithium compound to the mixture and performing the reaction by raising the temperature to 40° C. to 110° C.

8. The method for producing lithium difluorophosphate according to claim 1, wherein the step of producing the lithium difluorophosphate powder further comprises removing hydrogen halide (HX) gas from the lithium difluorophosphate compound in which the reaction is completed at a temperature of 10° C. to 25° C., filtering, and then washing with the organic solvent.

9. The method for producing lithium difluorophosphate according to claim 1, further comprising a step of further purifying the lithium difluorophosphate after the step of producing the lithium difluorophosphate powder.

10. The method for producing lithium difluorophosphate according to claim 9, wherein the step of further purifying comprises removing hydrogen halide (HX) gas from the lithium difluorophosphate powder at a temperature of 10° C. to 25° C., filtering, and then washing with an organic solvent to crystallize.

11. The method for producing lithium difluorophosphate according to claim 10, wherein the organic solvent comprises one or more selected from the group consisting of: ethers such as diethyl ether, diisopropyl ether, or methyl-t-butyl ether; esters such as methyl acetate, ethyl acetate, propyl acetate, or butyl acetate; nitriles such as acetonitrile, propionitrile, or butyronitrile; hydrocarbons such as pentane, hexane, heptane, or dialkoxyalkane; alcohols such as methanol, ethanol, propanol, or butanol; ketones such as acetone, ethyl methyl ketone, or methyl isopropyl ketone; carbonates such as dimethyl carbonate, diethyl carbonate, ethylene carbonate, or ethyl methyl carbonate; chloroalkanes such as methylene chloride, 1,2-dichloroethane, chloroform, or carbon tetrachloride; and aromatics such as benzene, toluene, or xylene.

12. Lithium difluorophosphate produced according to claim 1.
